(19) United States
(12) Patent Application Publication
(10) Pub. No.: US 2005/0075934 A1
(43) Pub. Date: Apr. 7, 2005

(54) Nutritional assistant for kiosk

(76) Inventors: Paul Knight, Fort Collins, CO (US); Larry Salmen, Fort Collins, CO (US)

Correspondence Address: COCHRAN FREUND & YOUNG LLC, 2026 CARIBOU DR, SUITE 200, FORT COLLINS, CO, 80525, US

(21) Appl. No.: 10/912,592

(22) Filed: Aug. 4, 2004

Related U.S. Application Data
(60) Provisional application No. 60/492,522, filed on Aug. 4, 2003.

(51) Int. Cl. A23L 1/30

(52) U.S. Cl. 705/15

(57) ABSTRACT

A consumer user interface for a point of sale food selection system is modified based on certain dietary requirements. The system and method may be applied to point of sale kiosks as well as wireless data devices for use in restaurants, delis, cafeterias, coffee shops and other food retail environments. During the process of ordering, the interface determines a user's preference for one or more dietary requirements. Once the preferences are determined, subsequent choices for an order may be suggested, highlighted, recommended, parsed, or otherwise modified to aid the consumer in selecting meals that are tailored to their individual preferences.

### CROSS REFERENCE TO RELATED APPLICATIONS

This application claims benefit of and priority to U.S. Provisional Patent Application Ser. No. 60/492,522 entitled “Nutritional Assistant for Kiosk” by Paul Knight and Larry Salmen, filed Aug. 4, 2003, the entire contents of which are specifically incorporated herein by reference for all it discloses and teaches.

### BACKGROUND OF THE INVENTION

a. Field of the Invention

The present invention pertains to point of sale kiosks and specifically to point of sale kiosks for food products that include nutritional information.

b. Description of the Background

Point of sale kiosks are used in many restaurant applications, especially for fast food restaurants where speed and low cost are important. In a typical kiosk, the consumer may be presented with a series of menu screens from which the consumer may select their meal. The menu screens may have graphical and text images to assist the consumer in selecting the appropriate items and navigating through the process. A kiosk may include a touch screen interface that presents graphically based menu items. The kiosk may display one or more buttons that the consumer can press to make selections. A typical system is disclosed in U.S. Pat. No. 5,806,071 issued Sep. 8, 1998 to Balderrama, Salmen, and Schneider entitled “Process and System for Configuring Information for Presentation at an Interactive Electronic Device” which is hereby specifically incorporated herein by reference for all it discloses and teaches.

Additionally, an interactive point of sale kiosk is generally connected to a computer system for the transmission of the consumer's order as well as processing any financial transactions. Such a computer system may have connections to a network that is internally or externally connected.

Many consumers have dietary preferences that may pose some difficulty in selecting a meal from a very broad menu of choices. For example, those consumers with a diabetic or other condition may require them to eat foods particularly low in sugar or other ingredients such as some forms of carbohydrates. Those consumers may have difficulty finding appropriate menu choices that are consistent with their dietary needs.

### SUMMARY OF THE INVENTION

The present invention overcomes the disadvantages and limitations of the prior art by providing a system and method for aiding a consumer in the selection of food items using an interactive, computerized user device such as a consumer interactive user point-of-sale interface that is consistent with the consumer's dietary requirements or preferences. The system and method may be applied to point of sale kiosks, as well as wireless data devices, for use in restaurants, delis, cafeterias, coffee shops and other retail environments. During the process of ordering, the interface obtains a user's preference for one or more dietary requirements or preferences and provides choices that meet those requirements or preferences. The choices for an order may be suggested, highlighted, recommended, parsed, or otherwise modified to aid the consumer in selecting meals that are tailored to individual preferences. Multiple requirements and preferences can be combined to generate custom selections for the purchaser.

An embodiment of the present invention may therefore comprise a method for assisting a consumer in selecting food items for purchase from a restaurant using an interactive, computerized user device based on dietary needs comprising: displaying a plurality of food items and menus together with a plurality of dietary menus based on specific dietary considerations on the interactive, computerized user device; identifying the specific dietary considerations on the interactive, computerized user device for each of the plurality of dietary menus; identifying dietary preferences from the plurality of dietary menus that correspond to specific dietary needs of the consumer whenever the consumer has provided preference information; and allowing the consumer to select at least one of the plurality of dietary menus using the interactive, computerized user device that meets the specific dietary needs of the consumer.

Another embodiment of the present invention may comprise a method of assisting a consumer in selecting food items and beverages from restaurants and coffee shops using an interactive, computerized user device based on dietary concerns of said consumer comprising: displaying the food items from an interactive, computerized menu on the interactive, computerized user device; displaying nutritional values for at least one of the food items on the interactive, computerized user device; determining preferences of said consumer based upon specific dietary concerns of the consumer; identifying a set of the food items that meet the specific dietary concerns of the consumer; and displaying the set of food items that meet the specific dietary concerns of the consumer on the interactive, computerized user device for selection by the consumer.

Yet another embodiment of the present invention may comprise a system for assisting a consumer in selecting food items based on dietary needs using an interactive, computerized menu comprising: a computerized, interactive display device; an input device coupled to the computerized, interactive display device; and, a computer program adapted to determine a set of dietary menus, and display, on the computerized, interactive display device, said food items corresponding to and based at least in part on the set of dietary menus for selection by the consumer, the set of dietary menus defined by a set of rules that specify maximum amounts of specified ingredients.

The advantages of the present invention are that the powerful database and sorting capability of a computer system may be used to assist a consumer in selecting a food product based on the consumer's particular dietary constraints. A very large selection of food may be presented in a manageable menu formats that are tailored for the consumer, enabling the consumer to select items that meet specific criteria in a speedy yet educated manner.

### BRIEF DESCRIPTION OF THE DRAWINGS

In the drawings,

FIG. 1 is an illustration of an embodiment of the present invention showing a method for ordering food on an interactive computer system that uses customer dietary preferences to aid in selection.

FIG. 2 is an illustration of an embodiment of the present invention showing a method for assisting a consumer in selecting food items that meet consumer dietary preferences.

FIG. 3 is an illustration of another embodiment of the present invention showing a method for assisting a consumer in selecting food items that meet consumer dietary preferences.

FIG. 4 is an illustration of an embodiment of the present invention showing a food ordering system.

FIG. 5 is an illustration of an embodiment of the present invention showing a user interface for selecting dietary preferences.

FIG. 6 is an illustration of an embodiment of the present invention showing a user interface that may be used for modifying or setting dietary preference rules.

FIG. 7 is an illustration of an embodiment of the present invention showing a user interface for ordering food items.

FIG. 8 is an illustration of an embodiment of the present invention showing a user interface for modifying an order for an item that is an assembly of various components.

### DETAILED DESCRIPTION OF THE INVENTION

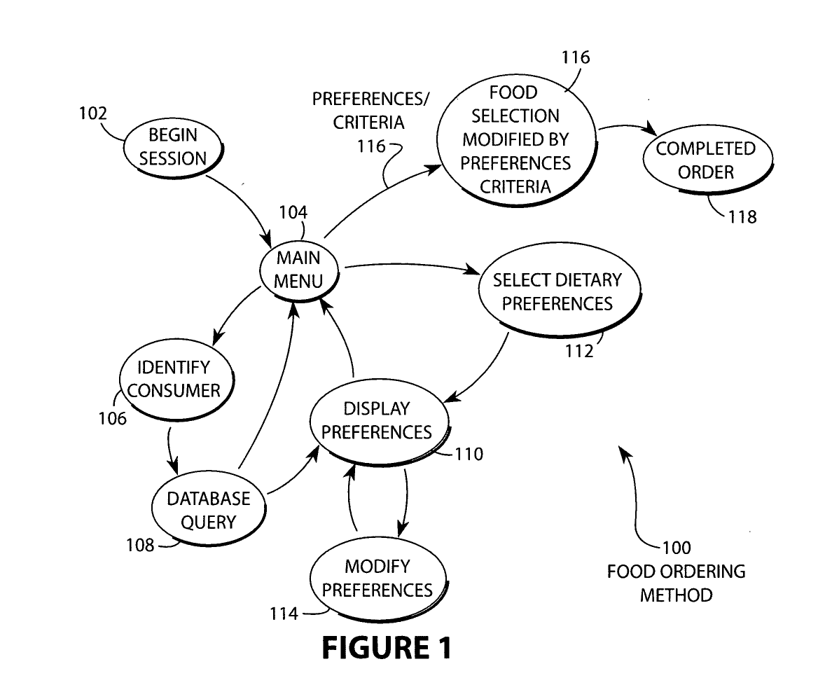

FIG. 1 illustrates an embodiment 100 of the present invention showing a method for ordering food on an interactive computer system that uses customer dietary preferences to aid in selection. The session begins in a start screen 102. Activation of the start screen cause the process to proceed to a main menu 104. The customer may be identified in block 106, a database may be queried in block 108, and their particular nutritional preferences or requirements may be displayed in block 110. In some cases, the customer may select dietary preferences in block 112 directly. When the preferences are displayed in block 110, the preferences may be modified in block 114. The criteria and preferences 116 are passed to the portion of the system where food selection is performed by the consumer in block 116. Subsequently, the process proceeds to completed order screen 118.

The embodiment 100 illustrates a method in which a customer's dietary preferences may be determined so that those preferences may be used to assist the customer in selecting food that corresponds to the customer preferences. Such a system may be useful for people with certain ailments or conditions such as diabetes, heart conditions, or other maladies. Such a system may also be adapted to help athletes with the proper nutrition for training as well as aiding the casual dieter in keeping on a particular diet plan.

The embodiment 100 may be used for the selection of food at a restaurant or other food venue. For example, such a system may be useful for a point-of-sale kiosk located in a fast food restaurant or other interactive menu system that may be used to order food.

In the embodiment 100, the consumer may have a predefined dietary preference that is stored in a database. When the consumer identifies himself or herself to the system in block 106, the database of consumer information may be queried in block 108 to bring up that particular customer's preferences. In some cases, the preferences may be strict, such as a vegan requirement where no animal proteins are tolerated or a particular medical condition where absolutely no more than a certain amount of salt is to be consumed. In other cases, the preferences may be general consumer preferences, such as preferring low fat items over greasy foods.

The consumer may identify himself or herself to the system by a number of different methods. For example, the consumer may insert a credit card, a debit card, an affinity card (such as a frequent card that identifies the customer and lists the customer's preferences), discount card, or other type of card issued by the restaurateur or association. Such cards may be used for collecting points based on the number of purchases or other such promotional card. In another embodiment, the consumer may enter or swipe a credit card or debit card that may be used to simultaneously identify the consumer as well as pay for the purchase. Additionally, the consumer may enter a code such as a password and pin or just a pin or name under which their preferences are stored. Further, biometrics may be used. For example, the system may include a fingerprint reader, a face recognition device, a retinal or iris scan device, a handprint reader, or other identifying device that uses biometrics.

In embodiments wherein the consumer places an order using their own electronic device, such as in electronic commerce applications or when ordering over the Internet, their electronic device may contain personalized data that may store the preferences on their device or in the restaurant's consumer database such as a data warehouse. In a web based application, a cookie or small data file may be stored in the consumer's web enabled device wherein the cookie may contain a link to the consumer's record in the database or the cookie itself may contain all of the preferences.

In other embodiments, the consumer may swipe a data card, such as an affinity card, that may have their specific preferences stored on the card itself. In such an embodiment, a remote database with personalized information may not be necessary as the specific dietary requirements are located within the card.

The predefined preferences may be determined by explicitly querying the consumer about their preferences, such as enabling the consumer to select their preferences in block 112. In other cases, the preferences may be determined off-line by logging onto a website whereby the consumer may define the preferences and save them for future visits to a restaurant that accesses the website. In still other cases, a medical practitioner, athletic trainer, or other third party may define the specific preferences, requirements, or other criteria and force such criteria to be applied when the consumer selects their meals. In yet other embodiments, the consumer's previous choices may be used to determine their specific preferences. For example, a consumer's history of previous orders may be analyzed to determine that a consumer may have specific dietary preferences such as done in data warehouse systems.

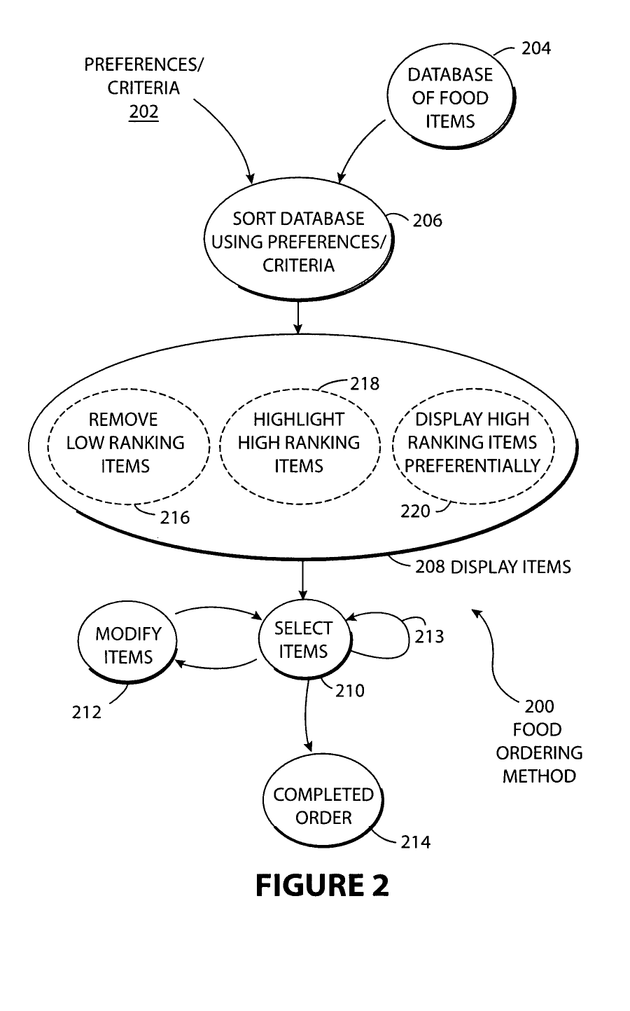

FIG. 2 illustrates an embodiment 200 of a method for ordering food wherein dietary preferences are used to assist the consumer in selecting items that match the preferences. The preferences or criteria 202 and the database of food items 204 are combined to produce a sorted list of food items in block 206. The items are displayed in block 208, the items selected in block 210, modified in block 212, and repeated as indicated by arrow 213 as necessary to produce a completed order in block 214.

The preferences and criteria 202 are combined with the database of available food items 204 to classify the food items prior to display. The classification process may involve removing unacceptable items, ranking items based at least in part on how well the items met the criteria, or some other classification process.

In some cases, the dietary preferences 202 may be combined with other unrelated dietary criteria to yield a sorted list. Such criteria may include factors as profitability, available inventory, special sales promotions, or any other non-dietary related factor. For example, if the consumer indicates a preference for low fat meals, within the group of ‘low fat’ meals, certain meals may have a higher profit margin. The higher profit margin meals may be offered preferentially while still using consumer preferences to aid in the selection of high profit meals.

The items may be displayed in block 208 in several different ways. For example, low ranking items may be removed in block 216, high ranking items may be highlighted in block 218, and high ranking items may be displayed preferentially in block 220. For the example of a point of sale kiosk, the consumer may be interacting with a display and a touch screen interface. When the menu is presented to the consumer using their preferences, some menu items may be deleted from the display or relegated to a secondary menu. In other embodiments, certain items that meet the criteria may be placed in ranked order or otherwise located in a preferential location. In some cases, the ranked order may not be readily apparent to the consumer, but may involve subtle changes to the display that encourage the consumer to select one item over another. Those skilled in the arts will appreciate that many different embodiments of modifying the manner of displaying items for selection may be accomplished while keeping within the spirit and intent of the present invention.

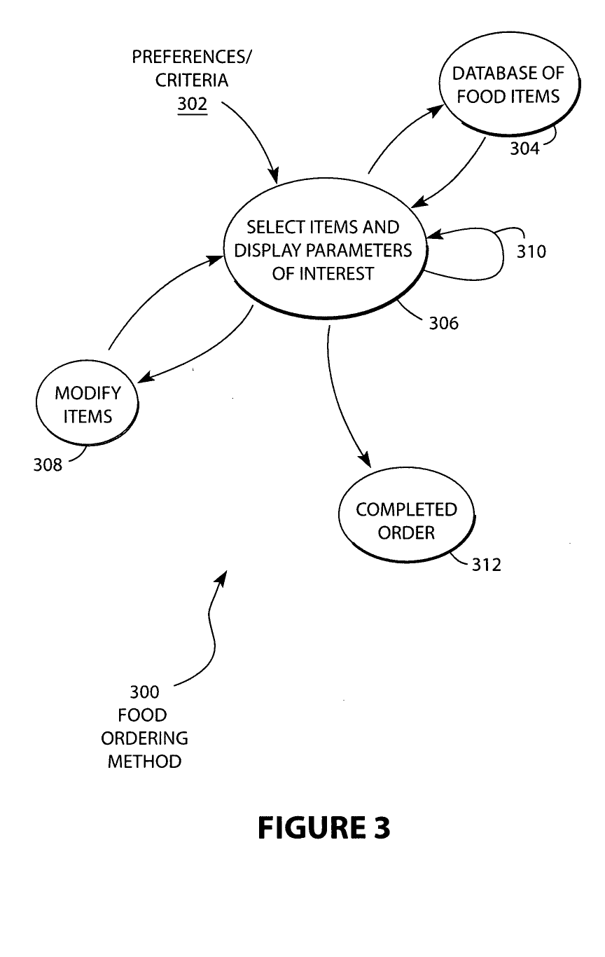

FIG. 3 illustrates an embodiment 300 of the present invention showing a method for assisting a consumer in selecting food items that meet consumer dietary preferences. The preferences 302 and database of food items 304 are used in the selection and display of items in block 306. The items may be modified in block 308 and more items ordered as indicated by the arrow 310 to produce a completed order 312.

The embodiment 300 provides an indicator of certain parameters of interest during the ordering process in block 306. Such indicators may be graphical enhancements to the screen or tabulated numerical values that count calories, fat, sodium, or other calculable values for the particular order.

When the consumer defines certain parameters of interest, those parameters may be added to the description of the food items and may be tabulated and summed for all of the items in a particular meal order. For example, if the consumer indicates that carbohydrates are of interest, some or all of the food choices may be listed with the carbohydrate information for each of the items. As several items are selected for a meal, the carbohydrates may be displayed for each item and a running total may also be displayed.

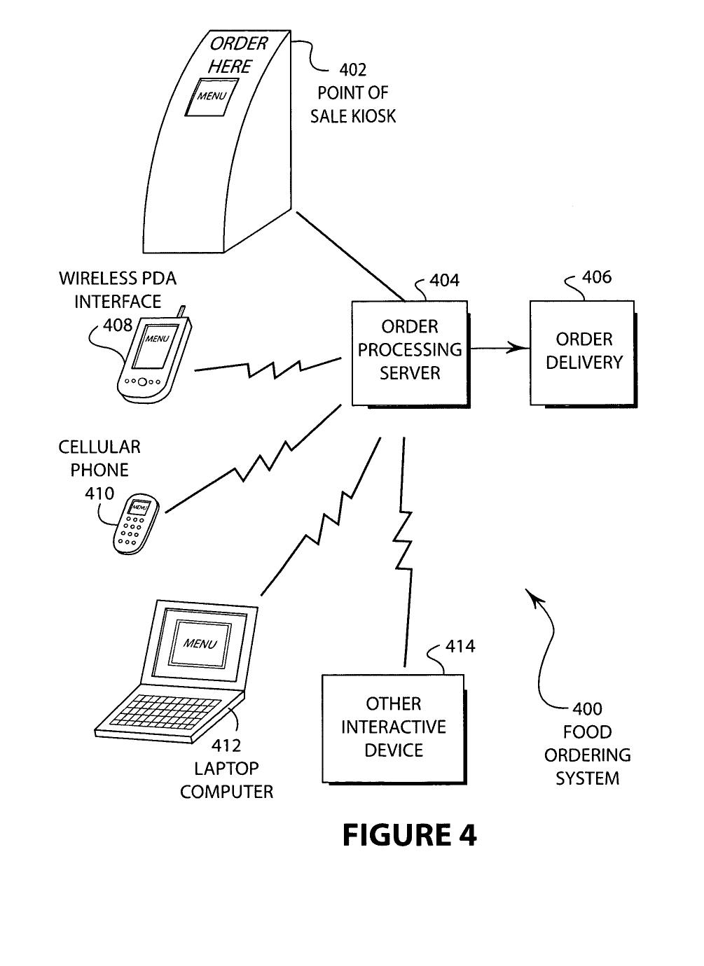

FIG. 4 illustrates an embodiment 400 of the present invention showing a food ordering system. A point of sale kiosk 402 may be connected to an order processing server 404 that results in an order delivery. Other interfaces to the order processing server 404 include a wireless PDA interface 408, a cellular phone interface 410, a laptop computer 412, or other interactive device 414.

The point of sale kiosk 402 may be located in a restaurant, deli, shopping center, cafeteria, or the like where a consumer may place an order. The completed order is then transmitted to the order processing server 404 that may be located in or near the kitchen so that the food order may be prepared according to the order. When the order is completed, the order may be delivered or the consumer may pick it up.

The user interface experienced by the consumer may be a dedicated interface such as the point of sale kiosk 402, a web page interface, or any other interactive computer interface as can be contemplated. A web page interface may be readily adapted to different devices.

Various wireless devices such as a PDA 408, cellular phone 410, a wireless enabled laptop 412, or other such device may be used in an electronic commerce application with the present invention. For example, a user may come into a coffee shop or restaurant with a wireless enabled laptop 412, log onto the web page for the coffee shop or restaurant using the wireless link in the coffee shop or restaurant, and place an order using a wireless device. The order may be delivered right to the consumer's table.

In some embodiments, the food items may be ready to eat, such as at a fast food restaurant, or the food items may be for later consumption or preparation. For example, a selection of food items for a deli, butcher shop, take out restaurant, pizza delivery house, or other food venue may be made at home over the Internet using a home computer and one of the various embodiments of the present invention. The ordered items may be prepared and ready for pick up or delivery to the consumer.

In accordance with one embodiment, aspects of the present invention may be located in a hospital or assisted living center where each patient or resident may be able to order a meal over an interactive interface. In such an embodiment, the interface may be through a web based interface such as a computer terminal, through an interactive television session, or any other interactive interface that may be adapted to the application.

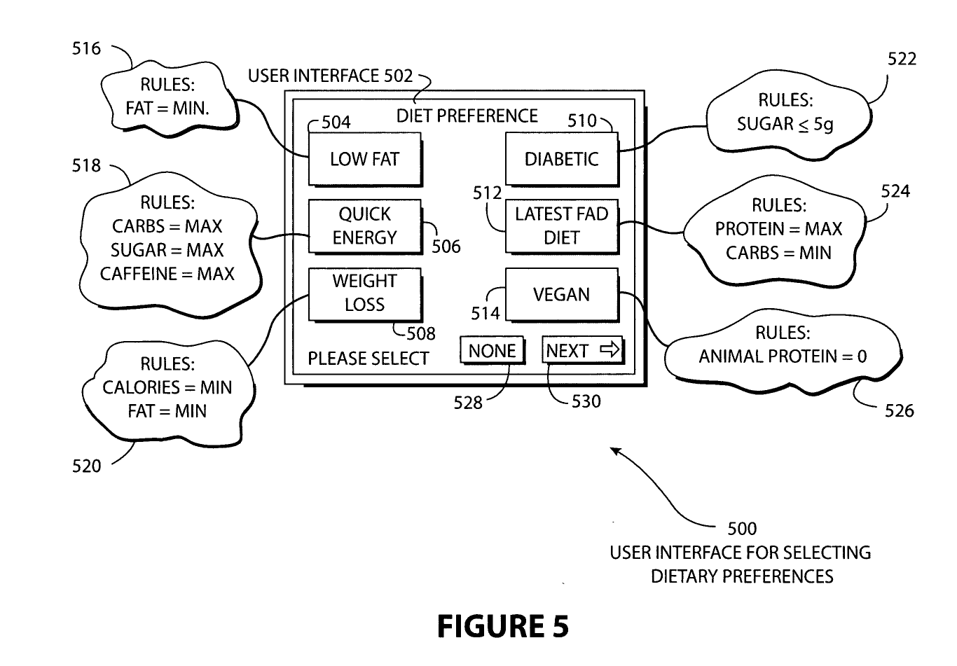

FIG. 5 illustrates an embodiment 500 of the present invention showing a user interface for selecting dietary preferences. The user interface 502 contains selection buttons 504, 506, 508, 510, 512, and 514 which may constitute displayed touch screen buttons, hard wired buttons or other interactive buttons capable of selection in various ways. For each button, there is a corresponding set of dietary rules 516, 518, 520, 522, 524, and 526. The user interface 502 also contains navigation buttons 528 and 530 which may also be displayed touch screen buttons or other interactive buttons capable of selection by various ways.

The user interface 502 may be a touch screen or other type of interactive interface. In the embodiment of a touch screen, each of the various buttons may be an active area of the screen wherein the consumer may simply touch the button to select. In a web based interface, the consumer may use a mouse, trackball, or other pointing device to select the button area.

For each button, there may be a set of corresponding rules that may be used to screen, sort, or otherwise modify or assist a consumer in selecting food products that meet the criteria. For example, the rules 518 corresponding to button 506 entitled “Quick Energy” comprise carbs=max, sugar=max, and caffeine=max. When these rules are applied to a database of food products that have values for carbohydrates, sugars, and caffeine, those food products with the highest amounts of the three variables may be ranked the highest.

Many different types of rules may be constructed by those skilled in the arts. For example, a rule may indicate that a value is to be maximized, minimized, held to zero, attain at least a minimum value, does not exceed a maximum value, or other types of rules or expressions of a dietary preference. Those skilled in the arts may express a dietary preference using many different expressions while keeping within the spirit and intent of the present invention.

The set of rules may be a computational representation of the dietary preferences. The purpose of the rules is to enable a computer to sort a database of food items based on the set of rules. The database may contain variables such as ‘calories’ that have specific numerical values on which computations may be performed. A database may contain Boolean variables such as ‘vegetarian’ that are either true or false. Those skilled in the art may use any variable suited to their particular application while keeping within the spirit and intent of the present invention.

Many types of dietary preferences may be defined for a consumer. In some cases, the dietary preferences are guidelines or recommendations that are not hard and fast. For example, a “Low Fat” preference may guide a consumer towards selections that are lower in fat, but still enable the consumer to select otherwise high fat foods. In other cases, the dietary preferences may specify that certain foods are absolutely prohibited and would therefore be completely eliminated from choice. In such an example, a diabetic selection may completely eliminate foods that exceed a certain level of sugar.

More than one selection may be made by the consumer. For example, a consumer may select the diabetic button 510, the vegan button 526, and the latest fad diet button 512 to create an aggregate of all the rules associated with those selections. In some embodiments where multiple selections are enabled, an arbitration method may be employed between conflicting sets of rules for particular circumstances and a particular user interface.

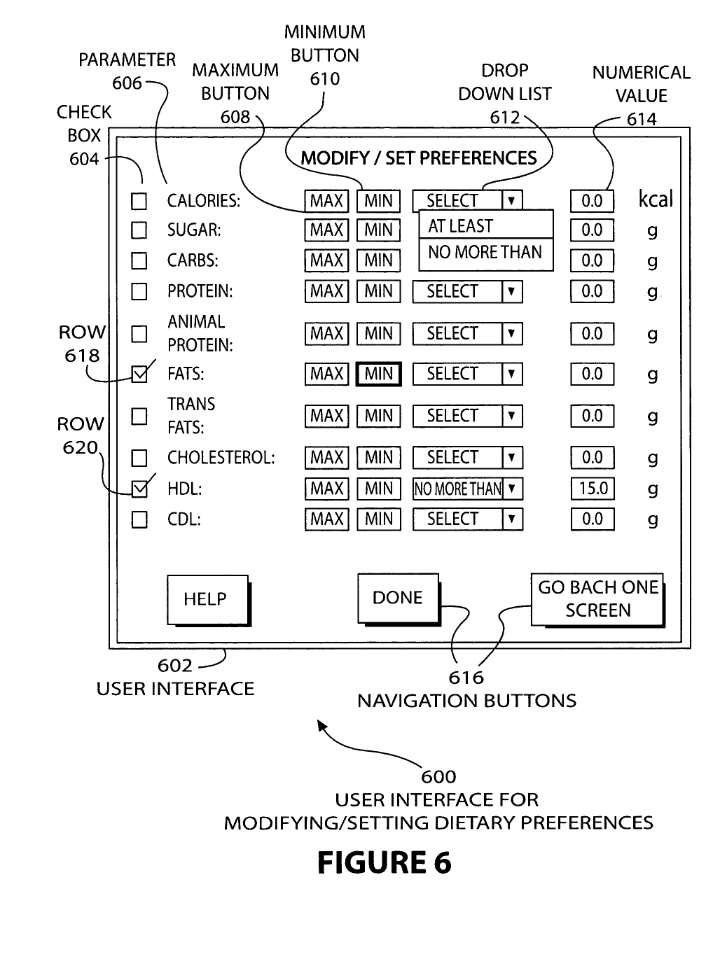

FIG. 6 illustrates an embodiment 600 of the present invention showing a user interface that may be used for modifying or setting dietary preference rules. The user interface 602 has a series of buttons having a check box 604, the parameter name 606, a maximum button 608, a minimum button 610, a drop down list with “at least” and “no more than” button 612, a numerical value 614, and navigation buttons 616.

The embodiment 600 may be an interactive interface whereby a consumer may view and edit various rules that define their dietary preferences. Such an embodiment may be used by a nutritionist, physician, trainer, dietitian, or other healthcare professional to prepare a specific regimen for the consumer.

Each row of items may be used to create or modify a rule. For example, in the row 618 where the parameter 606 is “fats”, the check box 604 is checked indicating that the rule defined by the row 618 is active. The min button 610 is highlighted indicating that the button is active. The rule defined by row 618 is to minimize fats. Likewise, row 620 is checked and defines a rule that HDL should be no more than 15.0 g.

The embodiment 600 is an example of a user interface that may be used to interactively define a set of rules that can be subsequently used to sort, categorize, or otherwise assist a consumer in selecting food products. Various different methods may be used for the consumer to define the specific rules while keeping within the spirit and intent of the present invention. For example, a set of rules may be defined by mere text or many different layouts and options are available for interactive mechanisms by which consumers may define their preferences.

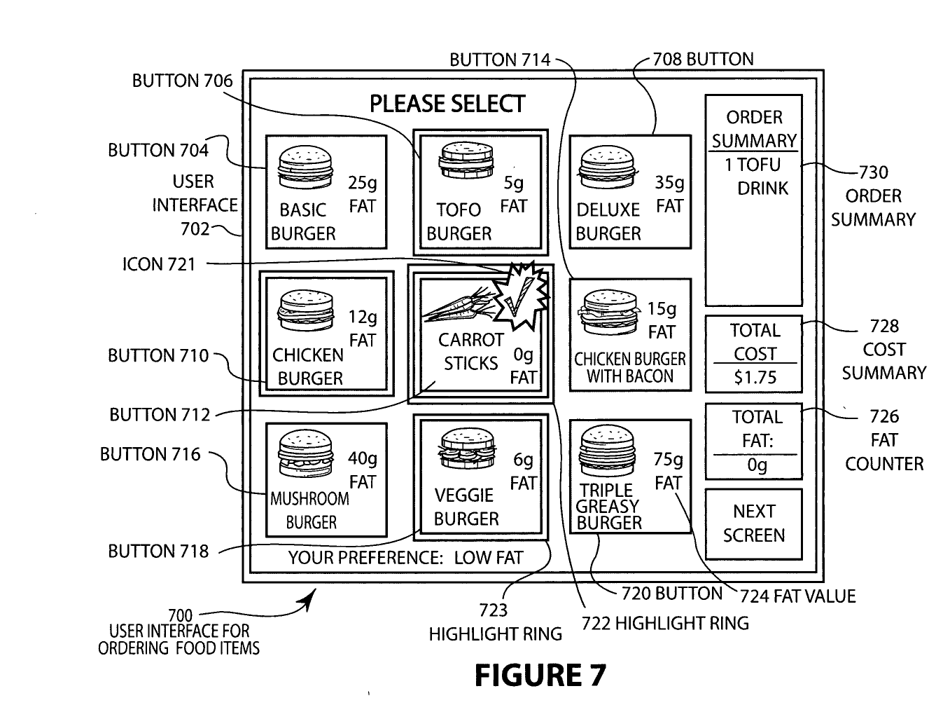

FIG. 7 illustrates an embodiment 700 showing a user interface for ordering food items. The user interface 702 contains buttons 704, 706, 708, 710, 712, 714, 716, 718, and 720. An icon 721 is used to indicate a preference for the item displayed in button 720. The fat value 724 is displayed in the button 720 and likewise for the other buttons. The fat counter 726 indicates the total fat content of the selected meal and in a similar fashion, the cost summary 728 contains the current total cost for the order. The order summary 730 contains all of the selected items for the current session.

The embodiment 700 illustrates several different ways in which consumers may be aided in selecting products that meet their requirements. Various graphical devices plus displayed data are demonstrated.

One manner in which a product may be promoted is by placing the most desirable product in the most desirable position. For example, the lowest fat item, carrot sticks, are placed in button 712 at the center of the screen. Two other low fat items are placed in buttons 704, 706, and 718 immediately to the side, above, and below the most preferred item. The product with the least appeal is placed in button 720 in the lower right hand corner and in the least desirable position.

The example of placing the most desirable item in the center of the screen may be appropriate for some screen layouts and inappropriate for other screen layouts. For example, the most prominent position on the screen may be the upper right hand position in some layouts.

A second manner in which a product may be promoted is to graphically highlight those items that are preferred. Button 712 for carrot sticks has two highlighting rings 722. Button 718 for veggie burger has one highlight ring 723.

A third manner in which a product may be promoted is the placement of overlays, icons, or other additional graphical indicators on the screen. For example, the icon 721 may be placed over an item that meets or exceeds the preferences. In other embodiments, the icon 721 may be a recognized icon that indicates that the item is in a special dietary category, such as a ‘heart healthy’ icon or other such designation.

A fourth manner in which a product may be promoted is the addition of calculable factors to the display, where the factors are of specific interest to the consumer. In the embodiment 700, the factor of interest is fat. The specific consumer has indicated a preference for low fat items, so fat is indicated on each item by a fat value 724 and the total amount of fat for the order is listed in the fat counter 726. In some embodiments, a recommended maximum or other helpful value may be added to the user interface 702 to help the consumer in their choices.

A fifth manner in which a product may be promoted may be by changing the color, intensity, or other graphical alteration to draw attention to or divert attention from a favorable or unfavorable item, respectively. For example, an item to be promoted may be specially colored or raised in intensity while an item to be demoted may be ‘grayed out’ or darkened slightly. In some embodiments, the color or intensity changes may be very subtle and designed to operate subliminally while in other embodiments, the contrast may be very sharp.

A sixth manner in which a product may be promoted may be by using animated graphical elements. Blinking highlights 722, animated graphics, and other moving and eye catching elements may be employed to help the consumer pick food items that meet their criteria.

A seventh manner in which a product may be promoted or demoted may be changing the amount of area on the screen dedicated to the product. Items to be promoted may be larger while items to be demoted may be made smaller and less significant.

Additional methods may be employed to promote items. For example, audible sound clips may be played that direct the consumer to specific items over another. Additionally, promoted items may be presented in a pop up window over the main ordering window. Those skilled in the arts will appreciate that many different embodiments may promote or demote various items while keeping within the spirit and intent of the present invention.

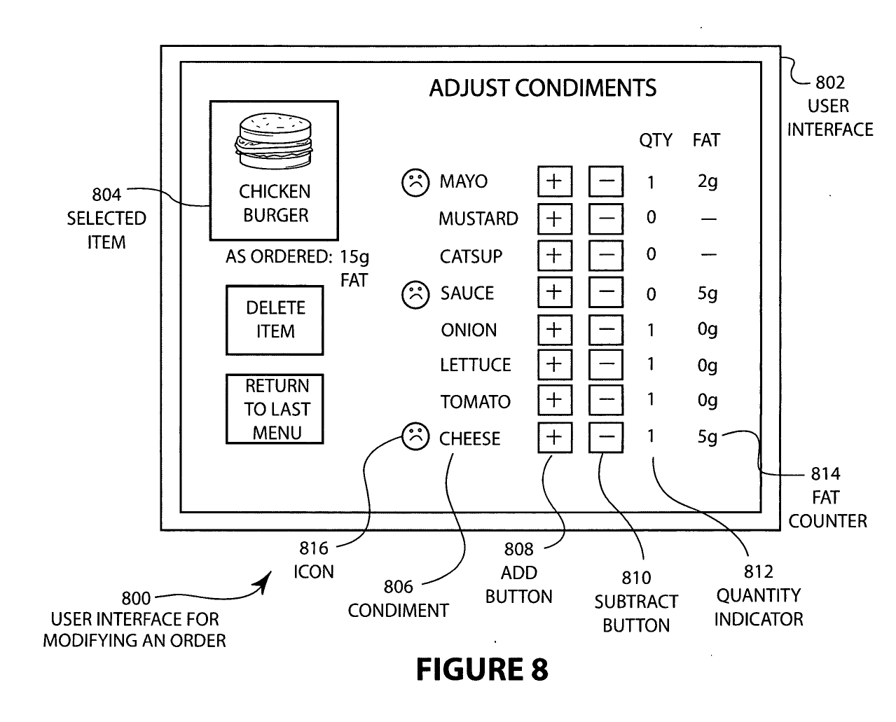

FIG. 8 illustrates an embodiment 800 of the present invention showing a user interface for modifying an order for an item that is an assembly of various components. The selected item 804 has a list of condiments 806 and add buttons 808 and subtract buttons 810 that effect the quantity 812. The amount of fat added by each item is displayed in the fat counter 814. Icons 816 indicate suggestions for meeting the consumer's goals.

The embodiment 800 is an interface by which a consumer may alter the quantity of components that make up a specific item. In the present example, the chicken burger 804 may be adjusted by adding or removing the various condiments 806. The consumer may press one the corresponding add button 808 or subtract button 810 to add or subtract the condiment from the sandwich.

The fat content 814 of the individual condiments are listed in the user interface 802. The fat content 814 enables the consumer to make an informed choice about their selected and customized food item. By enabling the consumer to see how much fat is added by each condiment, the consumer may thereby be directed toward ordering condiments that are lower in fat, presuming that the consumer wishes to minimize fat intake.

Icons 816 may be used to direct the consumer away from some items and towards other items. Various other methods may be used, as described in the discussion of FIG. 7, to graphically enhance specific items based on the nutritional preferences. Such methods may be applicable to the embodiment 800 to indicate condiments that would be preferred or not preferred.

The embodiment 800 may be used to suggest modifications to any food product that may be assembled into a single unit. In the case of an embodiment used for the selection of ingredients for a dish to be prepared at home, the consumer may have selected a bake-at-home turkey dinner that is made up of several different ingredients such as stuffing, rolls, various vegetables, the obligatory cranberries, and a selection of pies. The embodiment 800 may assist the consumer in selecting a particular type of cranberries that is low in fat or sugar content, or otherwise is more suited to their particular dietary requirements. When the consumer has completed their order, the store may prepare the order to be picked up. Another example is the selection of ingredients for a sandwich, pizza, or other type of food.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for assisting a consumer in selecting food items for purchase from a restaurant using an interactive, computerized user device based on dietary needs comprising:
displaying a plurality of food items and menus together with a plurality of dietary menus based on specific dietary considerations on said interactive, computerized user device;
identifying said specific dietary considerations on said interactive, computerized user device for each of said plurality of dietary menus;
identifying dietary preferences from said plurality of dietary menus that correspond to specific dietary needs of said consumer whenever said consumer has provided preference information; and
allowing said consumer to select at least one of said plurality of dietary menus using said interactive, computerized user device that meets said specific dietary needs of said consumer.

2. The method of claim 1 further comprising:
allowing said consumer to modify at least a portion of said dietary menu based on a set of said dietary preferences using said interactive, computerized user device by displaying dietary information for each food item in said at least one of said plurality of dietary menus selected by said consumer.

3. The method of claim 2 further comprising displaying rules established for said plurality of dietary menus that include criteria selected from the group consisting of calories, fat content, sugar content and salt content.

4. The method of claim 1 further comprising:
determining the identity of said consumer; and
retreiving said set of dietary preferences from a database that stores said set of dietary preferences for said consumer.

5. The method of claim 4 wherein said determining the identity of said consumer comprises reading an identification card of said consumer.

6. The method of claim 5 wherein said identification card is a credit card.

7. The method of claim 2 wherein said process of modifying at least a portion of said menu comprises:
ranking at least a portion of said menu items based at least in part upon said set of dietary preferences to produce a ranked order list of said menu items; and
displaying said menu items based on said ranked order list.

8. The method of claim 7 wherein said process of displaying said menu items based on said ranked order list comprises:
defining a preferential location for a preferred menu item; and
displaying a menu item in said preferential location based on said ranked order list.

9. The method of claim 7 wherein said process displaying said menu items based on said ranked order list comprises:
defining at least one item from said ranked order list that does not meet said set of dietary preferences; and
not displaying said at least one item from said ranked order list.

10. A method of assisting a consumer in selecting food items and beverages from restaurants and coffee shops using an interactive, computerized user device based on dietary concerns of said consumer comprising:
displaying said food items from an interactive, computerized menu on said interactive, computerized user device;
displaying nutritional values for at least one of said food items on said interactive, computerized user device;
determining preferences of said consumer based upon specific dietary concerns of said consumer;
identifying a set of said food items that meet said specific dietary concerns of said consumer; and
displaying said set of food items that meet said specific dietary concerns of said consumer on said interactive, computerized user device for selection by said consumer.

11. The method of claim 10 further comprising displaying a total value for a plurality of nutritional values for a plurality of said food items.

12. The method of claim 10 wherein at least one of said food items is an assembly of a plurality of food stuffs, the method further comprising:
displaying at least one of said food stuffs; and
modifying the quantity of at least one of said food stuffs.

13. The method of claim 12 further comprising:
determining the identity of said consumer; and
determining a set of dietary preferences from a database having a relationship between said identity of said consumer and said set of dietary preferences.

14. The method of claim 13 wherein said process of determining the identity of said consumer comprises reading an identification card of said consumer.

15. The method of claim 13 wherein said identification card is a credit card.

16. A system for assisting a consumer in selecting food items based on dietary needs using an interactive, computerized menu comprising:
a computerized, interactive display device;
an input device coupled to said computerized, interactive display device; and,
a computer program adapted to determine a set of dietary menus, and display, on said computerized, interactive display device, said food items corresponding to and based at least in part on said set of dietary menus for selection by said consumer, said set of dietary menus defined by a set of rules that specify maximum amounts of specified ingredients.

17. The system of claim 16 wherein said computer program is further adapted to enable said consumer to change at least one of said rules using said input device.

18. The system of claim 17 wherein said computer program is further adapted to:
determine the identity of said consumer; and
determine a set of dietary preferences for said consumer from a database having a relationship between said identity of said consumer and said set of dietary preferences.

19. The system of claim 18 further comprising:
a card reader; and
wherein said computer program is further adapted to determine the identity of said consumer by reading a card of said consumer using said card reader.

20. The system of claim 19 wherein said computer program is further adapted to highlight at least one item based upon said set of dietary preferences, said at least one item being an item that is preferred based upon said set of dietary preferences.

21. The system of claim 19 wherein said computer program is further adapted to modify at least a portion of said display of said food items by:
ranking at least a portion of said food items based at least in part upon said set of dietary preferences to produce a ranked order list of said menu items; and
displaying said food items based on said ranked order list.

22. The system of claim 21 wherein said computer program is further adapted to display said food items based on said ranked order list by:
defining a preferential location for a preferred food item; and
displaying said preferred food item in said preferential location based on said ranked order list.

23. The system of claim 21 wherein said computer program is further adapted to display said food items based on said ranked order list by:
defining at least one food item from said ranked order list that does not meet said set of dietary preferences; and
not displaying said at least one item from said ranked order list.

24. The system of claim 21 wherein said input device is a touch screen.

25. The system of claim 21 wherein said display device is part of an interactive kiosk.

26. The system of claim 21 wherein said display device is part of a personal data manager.

27. The system of claim 26 further comprising:
a server system;
a wireless communication system that communicates with said server; and
wherein said personal data manager comprises a wireless communications transceiver that transmits and receives information regarding selection of said food items over said wireless communication system.

28. The system of claim 27 wherein said personal data manager is a portable computer.

29. The system of claim 28 wherein said portable computer comprises a handheld device.

30. The system of claim 29 wherein said handheld device is a cellular telephone.

31. The system of claim 29 wherein said handheld device is a personal data assistant.
